(19) United States
(12) Patent Application Publication
(10) Pub. No.: US 2014/0008488 A1
(43) Pub. Date: Jan. 9, 2014

(54) CONVERTER WITH TAXI DRIVE

(71) Applicant: John N. Buzzard, Rockford, IL (US)

(72) Inventor: John N. Buzzard, Rockford, IL (US)

(73) Assignee: HAMILTON SUNDSTRAND CORPORATION, Windsor Locks, CT (US)

(21) Appl. No.: 13/543,241

(22) Filed: Jul. 6, 2012

(51) Int. Cl. B64D 41/00

(52) U.S. Cl. 244/50

(57) ABSTRACT

Embodiments are directed to a converter for an aircraft configured to produce constant frequency power from variable frequency power received from a variable speed generator when the aircraft is in flight and to be utilized as a motor drive during taxi operations of the aircraft. Embodiments are directed to determining that an aircraft is on the ground, responsive to determining that the aircraft is on the ground, providing by a converter power to a motor drive to provide taxi operations, determining that the aircraft is in flight subsequent to determining that the aircraft is on the ground, and responsive to determining that the aircraft is in flight, producing by the converter constant frequency power from variable frequency power received from a variable speed generator.

### BACKGROUND

A drive system may provide traction drive to an aircraft's wheels to move the aircraft on the ground. For example, such traction drive may be used to move or displace an airplane during taxi operations. An auxiliary power unit (APU) may provide electric power to the system to facilitate the traction drive. During ground/taxi operations, the main engines of the aircraft may be shut down or turned off to conserve fuel.

An electric taxi (eTaxi) system may include a motor controller that converts aircraft electric power to a variable frequency, variable voltage that may be used to operate a traction motor. The traction motor may provide torque to a transmission clutch assembly that may drive landing gear, such as landing gear wheels that move or displace the aircraft.

During flight, the aircraft carries the weight of the motor controller, but the motor controller does not provide a flight function. The additional weight increases the cost of operating the aircraft. For example, the weight imposes a cost in terms of excess fuel consumption and imposes additional strain on the aircraft chassis or body. Furthermore, the presence of the motor controller represents a potential failure point, thereby degrading the reliability of the aircraft.

### BRIEF SUMMARY

An embodiment of the disclosure is directed to a system comprising a converter for an aircraft configured to produce constant frequency power from variable frequency power received from a variable speed generator when the aircraft is in flight and to be utilized as a motor drive during taxi operations of the aircraft.

An embodiment of the disclosure is directed to a method comprising determining that an aircraft is on the ground, responsive to determining that the aircraft is on the ground, providing by a converter power to a motor drive to provide taxi operations, determining that the aircraft is in flight subsequent to determining that the aircraft is on the ground, and responsive to determining that the aircraft is in flight, producing by the converter constant frequency power from variable frequency power received from a variable speed generator.

An embodiment of the disclosure is directed to a system comprising an auxiliary generator configured to provide power to a converter to drive a traction motor during a taxi operation of an aircraft with all main engines of the aircraft shut down, and a variable frequency generator configured to provide power to the converter to drive a load of the aircraft at a constant frequency during flight.

Additional embodiments are described below.

### BRIEF DESCRIPTION OF THE DRAWINGS

The present disclosure is illustrated by way of example in the accompanying figures, in which:

FIG. 1 illustrates an exemplary system architecture in accordance with one or more aspects of this disclosure; and

FIG. 2 illustrates an exemplary method in accordance with one or more aspects of this disclosure.

### DETAILED DESCRIPTION

Aspects of this disclosure provide for a reduction in the weight of an aircraft by utilizing an electric taxi (eTaxi) motor drive as a variable speed/constant frequency converter during flight. Accordingly, using the eTaxi drive in such a manner allows for the elimination of a constant speed drive, which can result in a reduction of weight and/or operating cost in one or more embodiments.

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this regard, as used herein a coupling of entities may refer to a direct or an indirect connection. Of course, to the extent the specification does not specifically provide for a direct connection, to the extent a direct connection is shown in the Figures, a direct connection can be implied but is not required and shall not limit the claims unless specifically recited in the claims.

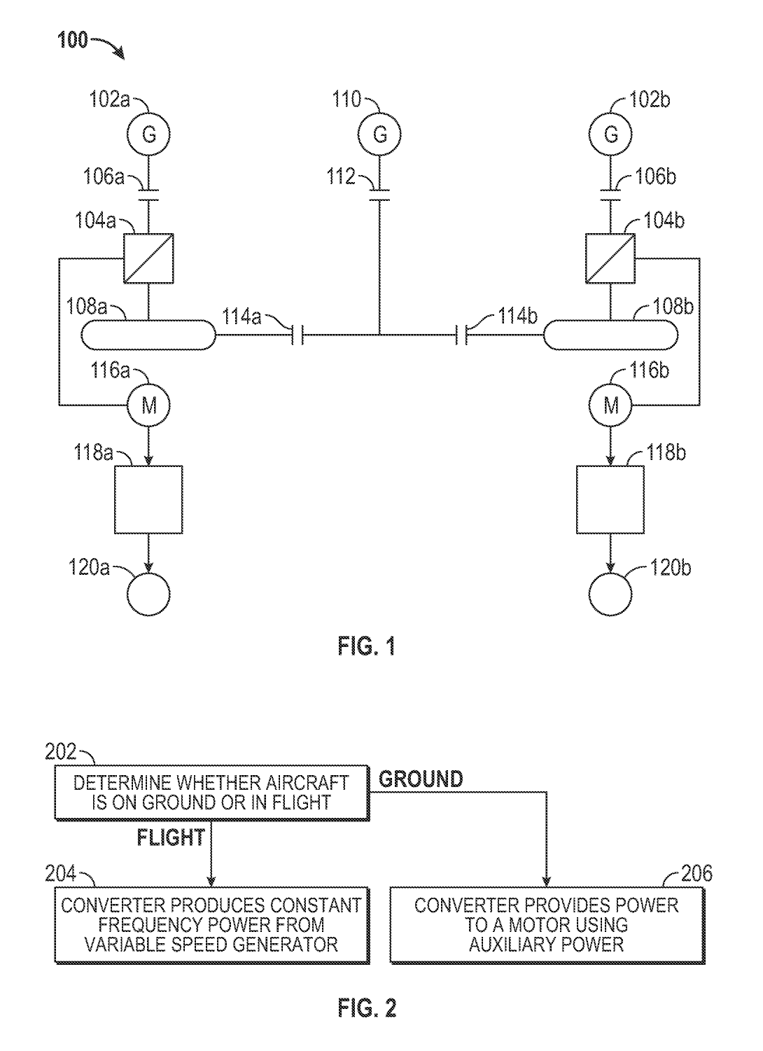

FIG. 1 illustrates a system architecture 100. The architecture 100 may be associated with an aircraft, such as an airplane. The architecture 100 may be used to produce power for the aircraft during ground/taxi operations and during flight.

In some embodiments, the architecture 100 may include one or more generators. For example, in FIG. 1 the architecture 100 includes two generators 102a and 102b. In one embodiment, the generators 102a and 102b are variable frequency generators. The generators 102a and 102b may be associated with, or receive mechanical energy/power from, the main engine(s) of the aircraft (e.g., the turbines) in a so-called “direct drive” configuration. The generators 102a and 102b may produce variable or constant frequency alternating current (AC) power depending on the context. In the following description, the generators 102a and 102b shall be referred to as variable frequency generators to describe a particular non-limiting embodiment.

The variable frequency generators 102a and 102b may be coupled to one or more entities. For example, as shown in FIG. 1 the variable frequency generator 102a may be coupled to a variable frequency converter/motor controller 104a via a contactor, such as a line contactor 106a. Similarly, the variable frequency generator 102b may be coupled to a variable frequency converter/motor controller 104b via a contactor, such as a line contactor 106b.

The variable frequency converters/motor controllers 104a and 104b may be configured to produce constant frequency power from the variable frequency AC power provided by the variable frequency generators 102a and 102b. The constant frequency power may be used by the aircraft during flight. The constant frequency power produced by the variable frequency converters/motor controllers 104a and 104b may be provided to alternating current (AC) buses 108a and 108b, respectively.

In some embodiments, the architecture 100 may include an auxiliary generator 110. The auxiliary generator 110 may be associated with one or more auxiliary power units (APUs). In some embodiments, such as in an aircraft environment, the APU(s)/auxiliary generator 110 may produce 115V at 400 Hz.

The auxiliary generator 110 may be coupled to the variable frequency converters/motor controllers 104a and 104b via one or more entities. For example, as shown in FIG. 1, the auxiliary generator 110 may be coupled to the variable frequency converter/motor controller 104a via a line contactor 112, a bus tie contactor 114a, and the AC bus 108a. Similarly, the auxiliary generator 110 may be coupled to the variable frequency converter/motor controller 104b via the line contactor 112, a bus tie contactor 114b, and the AC bus 108b.

The voltage or power produced by the auxiliary generator 110 may be provided to traction motors 116a and 116b via the variable frequency converters/motor controllers 104a and 104b, respectively. The traction motor 116a may provide torque to a transmission clutch assembly 118a to drive a wheel 120a. Similarly, the traction motor 116b may provide torque to a transmission clutch assembly 118b to drive a wheel 120b. In this manner, the auxiliary generator 110 may provide or source power for an aircraft during eTaxi or ground operations.

As one skilled in the art would appreciate, the various contactors (e.g., contactors 106a, 106b, 112, 114a, and 114b) associated with the architecture 100 may be used for selectively switching power, and may be used to provide isolation.

The variable frequency converters/motor controllers 104a and 104b may be used to create constant frequency electric power for consumption by equipment loads, such as an aircraft air conditioning unit during flight. The variable frequency converters/motor controllers 104a and 104b may also be used as a motor drive for eTaxi or ground operations, optionally with the main engines of an aircraft shut down. As such, in some embodiments a constant speed drive associated with various aircraft configurations may be eliminated. In some embodiments, a converter may be used to provide power for an aircraft during ground/taxi operations and during flight.

FIG. 2 illustrates a method that may be used to produce power for an aircraft. The produced power may be used by the aircraft during eTaxi/ground operations or during flight.

In block 202, a determination may be made whether the aircraft is on the ground or in flight. The determination may be based on one or more inputs, factors, or conditions. In some embodiments, one or more signals (e.g., aircraft discretes) may serve to indicate whether the aircraft is on the ground or in flight or the main engines are running In some embodiments, if the pilot is running the main engines, the engine generators may be producing electricity for the aircraft, and any taxi maneuver may be accomplished via engine thrust.

If, as determined in block 202, the aircraft is in flight or main engines running, a converter (e.g., the variable frequency converter/motor controller 104a) may produce constant frequency power from a variable speed generator (e.g., the variable frequency generator 102a) in block 204. If the aircraft is on the ground and in eTaxi mode, as determined in block 202, the converter may provide power to a motor (e.g., the traction motor 116a) using auxiliary power (e.g., as supplied by the auxiliary generator 110) in block 206, thereby allowing the main engine(s) of the aircraft to be shut down or turned off to conserve fuel.

It will be appreciated that the blocks or events of the method of FIG. 2 are illustrative in nature. In some embodiments, one or more of the events (or a portion thereof) may be optional. In some embodiments, one or more events not shown may be included. In some embodiments, the events may execute in an order or sequence different from what is shown in FIG. 2.

In some embodiments various functions or acts may take place at a given location and/or in connection with the operation of one or more apparatuses or systems. In some embodiments, a portion of a given function or act may be performed at a first device or location, and the remainder of the function or act may be performed at one or more additional devices or locations. Embodiments of the disclosure may be directed to one or more systems, apparatuses, and methods.

Embodiments may be tied to particular machines. For example, in some embodiments a power converter may be configured to produce constant frequency power from a variable speed generator in flight. That same power converter may be utilized as an eTaxi motor drive during taxi operations, with one or more main engines shut down.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional in accordance with aspects of the disclosure.

What is claimed is:

1. A system comprising:
a converter for an aircraft configured to produce constant frequency power from variable frequency power received from a variable speed generator when the aircraft is in flight and to be utilized as a motor drive during taxi operations of the aircraft.

2. The system of claim 1, wherein the converter is configured to be utilized as a motor drive during the taxi operations with all of the main engines associated with aircraft shut down.

3. The system of claim 1, wherein the converter is configured to receive electric power from an auxiliary generator when utilized as the motor drive during the taxi operations.

4. The system of claim 1, wherein the variable speed generator is configured to be driven by at least one main engine of the aircraft.

5. The system of claim 1, wherein the converter is configured to drive a traction motor during the taxi operations.

6. The system of claim 5, wherein the traction motor is configured to provide torque to a clutch assembly that is configured to drive a wheel of the aircraft.

7. The system of claim 1, further comprising:
a second converter for the aircraft configured to produce constant frequency power from variable frequency power received from a second variable speed generator in flight and to be utilized as a second motor drive during the taxi operations.

8. A method comprising:
determining that an aircraft is on the ground;
responsive to determining that the aircraft is on the ground, providing by a converter power to a motor drive to provide taxi operations;
determining that the aircraft is in flight subsequent to determining that the aircraft is on the ground; and
responsive to determining that the aircraft is in flight, producing by the converter constant frequency power from variable frequency power received from a variable speed generator.

9. The method of claim 8, further comprising:
shutting down all main engines of the aircraft during the taxi operations.

10. The method of claim 8, wherein the taxi operations comprise displacement of the aircraft.

11. The method of claim 8, further comprising:
receiving, by the converter, electric power from an auxiliary generator for the taxi operations.

12. The method of claim 8, further comprising:
driving the variable speed generator by at least one main engine of the aircraft.

13. The method of claim 8, further comprising:
driving, by the converter, a traction motor during the taxi operations.

14. The method of claim 13, further comprising:
providing, by the traction motor, torque to a clutch assembly configured to drive a wheel of the aircraft.

15. The method of claim 8, further comprising:
responsive to determining that the aircraft is on the ground, providing by a second converter power to a second motor drive to provide the taxi operations; and
responsive to determining that the aircraft is in flight, producing by the second converter constant frequency power from variable frequency power received from a second variable speed generator.

16. A system comprising:
an auxiliary generator configured to provide power to a converter to drive a traction motor during a taxi operation of an aircraft with all main engines of the aircraft shut down; and
a variable frequency generator configured to provide power to the converter to drive a load of the aircraft at a constant frequency during flight.

17. The system of claim 16, further comprising:
a first line contactor, a bus tie contactor, and an alternating current (AC) bus configured to couple the auxiliary generator to the converter; and
a second line contactor configured to couple the variable frequency generator to the converter.

18. The system of claim 16, wherein the variable frequency generator is configured to receive input mechanical power from at least one of the main engines of the aircraft.
